(19) United States
(12) Patent Application Publication
(10) Pub. No.: US 2026/0078930 A1
(43) Pub. Date: Mar. 19, 2026

(54) REFLECTOR PANEL ASSEMBLY

(71) Applicant: Australian National University, Acton, Australian Capital Territory (AU)

(72) Inventors: Johannes Joubert POTTAS, Centenary Heights (AU); Joseph Sydney COVENTRY, Watson (AU); Roelof Johannes Hendrik POTTAS, Nerang (AU)

(73) Assignee: Australian National University, Acton, Australian Capital Territory (AU)

(21) Appl. No.: 19/110,019

(22) PCT Filed: Sep. 8, 2023
(86) PCT No.: PCT/AU2023/050871

§ 371 Date: Mar. 7, 2025

(30) Foreign Application Priority Data
Sep. 9, 2022 (AU) 2022902611

(51) Int. Cl. F24S 23/70; B21D 22/02; B32B 3/30; B32B 15/01; F24S 23/75

(52) U.S. Cl. CPC F24S 23/82; B21D 22/02; B32B 3/30; B32B 15/012; B32B 15/013; F24S 23/75; B32B 2250/02; B32B 2307/416; B32B 2311/20; B32B 2311/24; B32B 2311/30; B32B 2551/00; F24S 2023/872

(57) ABSTRACT

Disclosed is a reflector panel assembly for use in a concentrated solar power system, the assembly comprising a reflector comprising a sheet element having a front surface and a rear surface, the reflector configured to receive and reflect electromagnetic radiation incident on the sheet element, a base configured to support the reflector such that a contact surface between the rear surface and the base is configured to maintain a predetermined shape of the reflector. Disclosed also is a base configured to support a reflector for use in a concentrated solar power system, the base composed of sheet material and comprising a plurality of protrusions spaced apart across a surface of the base, the plurality of protrusions extending to contact portions at peaks of the protrusions, the contact portions configured to form a contact surface which supports the reflector.

### TECHNICAL FIELD

This disclosure relates to the field of support structures for reflector panels. More specifically, the disclosure relates to support structures for supporting reflector panels used in a concentrated solar power system.

### BACKGROUND ART

It is to be understood that, if any prior art is referred to herein, such reference does not constitute an admission that the prior art forms a part of the common general knowledge in the art, in Australia or any other country.

Reflector panels are employed in a variety of applications such as satellite dishes, radio telescopes, concentrated solar power systems etc. to gather and process electromagnetic radiation. The gathered electromagnetic radiation is redirected to a receiver to utilize/process the radiation. In concentrated solar power systems, sunlight gathered by reflectors can be used to generate heat that may be utilized for a variety of purposes such as heating fluids or particles, driving thermal and chemical processes, etc. In concentrated photovoltaic systems, sunlight gathered by reflectors can be converted directly to electricity. The capacity of the reflector panels to accurately concentrate sunlight to a desired focal point or focal region has direct impact on the design and performance of the energy collection device (i.e. the solar receiver or solar reactor). Improvements to the optical accuracy of reflector panels may lead to a reduced size of the solar receiver (hence lower cost) and to higher efficiency in collecting the sunlight, and therefore, accurately curved reflector panels are sometimes used. Furthermore, the reflector panels need to be constructed such that they maintain an acceptable optical accuracy during operation under the influence of external loads such as gravity and wind. They also need to be able to survive wind loads experienced during storm conditions when in a stow position.

One type of construction that is conventionally used for reflector panels is a sandwich panel type construction. In this construction, a porous core material is sandwiched between two stiff face sheets, one of which has a reflective surface. While such a construction provides accuracy, it has attendant problems. For example, moisture may become entrapped in the porous core leading to moisture damage, such as corrosion or failure of adhesives. The core may be susceptible to ultraviolet (UV) degradation thus requiring the use of light blocking edges that would add to the complexity of fabrication as well as costs. Another type of construction used for reflector panels is to have a glass reflective sheet bonded to a stamped steel support. Conventionally the stamped metal support consists of concentric ring-like raised features, combined with radial rib-like raised features. The support has cut-outs between these raised features to reduce the weight of the support. Contact between the support and the mirror occurs at the edges of the ring and rib features. However, this panel is constrained in its capability for achieving high shape accuracy. A third option for reflector panels is a glass-only construction, with the curvature provided by external support frames. This type of concentrator uses an assembled, welded or joined frame consisting of standard structural members such as light-gauge folded steel sections. The mirror is held in the desired shape using a number of connecting elements between the frame and the mirror.

The location of the connections are constrained by the geometry of the frame, which imposes limits to how accurately the mirror can be shaped. This type of concentrator is also complicated to manufacture and assemble. Accordingly, there exists a need for a cheaper and more effective reflector panel that can maintain the accuracy of a curved mirror and be mass produced.

### SUMMARY

Disclosed in some forms is a reflector panel assembly for use in a concentrated solar power system, the assembly comprising a reflector comprising a sheet element configured to receive and reflect electromagnetic radiation, the sheet element having a front surface on which electromagnetic radiation is incident and a rear surface; and a base configured to support the reflector such that a contact surface between the rear surface and the base is configured to maintain a predetermined shape of the reflector.

In some forms the base comprises a plurality of protrusions extending from a rear base surface to form a contact surface spaced apart from the rear base surface.

In some forms the contact surface of the base comprises a plurality of spaced apart contact surface portions formed at a peak of each of at least a portion of the protrusions.

In some forms, the protrusions are generally frusto-conical extending from a base at the rear base surface to the contact surface.

In some forms the plurality of protrusions are evenly spaced apart on the base and/or are located in a regular pattern on the base.

In some forms the base is composed of sheet metal.

In some forms the base is formed and the protrusions are manufactured through any sheet forming process. In some forms the protrusions are formed through sheet metal stamping. In some forms the protrusions are formed through turret punching. In some forms the protrusions are formed through incremental sheet forming (ISF). In some forms, these processes offer the ability to manufacture the base on a large scale in an efficient and cost-effective manner.

The assembly may have the benefit of providing a base with sufficient support to a reflector to allow for accurate curvature of the reflector to be maintained, while also being efficient and inexpensive to manufacture, allowing for mass manufacture of the base and the reflector assembly.

Further disclosed is a base configured to support a reflector for use in a concentrated solar power system, the base composed of sheet material and comprising a plurality of protrusions spaced apart across a surface of the base, the plurality of protrusions extending from a rear surface to contact portions at peaks of the protrusions, the contact portions configured to form a contact surface which supports the reflector in use.

In some forms, the base is composed of sheet metal and the protrusions are formed by sheet metal forming processes including stamping, turret punching and incremental sheet forming.

Further disclosed is a method of manufacturing a base to support a reflector for use in a concentrated solar power system, the method comprising providing a sheet material, forming a plurality of protrusions in sheet material, the plurality of protrusions being spaced apart across a surface of the base and extending to contact portions at a peak of each protrusion, the contact portions configured to together form a contact surface which supports the reflector.

The use of sheet metal forming in production of the base allows for use of an efficient and inexpensive mass manufacturing process that reduces overall costs and provides consistency in output.

### BRIEF DESCRIPTION OF THE DRAWINGS

Embodiments will now be described by way of example only, with reference to the accompanying drawings in which:

FIGS. 1a and 1b show front and rear perspective views of a reflector assembly of one embodiment of the disclosure;

FIG. 2 shows a side perspective view of a base and reflector of one embodiment of the disclosure;

FIG. 3 shows a side view of the base and reflector of FIG. 2;

FIG. 4 shows a top view of the base and reflector of FIG. 2;

FIG. 5 shows a top view of a base of one embodiment of the disclosure;

FIG. 6 shows a top view of a base of a further embodiment of the disclosure;

FIG. 7 shows a top view of a base of one embodiment of the disclosure;

FIG. 8 shows a side perspective view of the base of FIG. 7.

FIG. 9 shows a perspective view of an installed solar panel reflector assembly comprising a base of one embodiment of the disclosure.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised, and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure. In this embodiment, the concentrated solar power system is a heliostat-based system, utilising reflective surfaces or mirrors to direct light from the sun toward a solar receiver for absorption. While the disclosure has been described in relation to a heliostat system, it will be clear to users skilled in the art that the assembly may form part of any solar system in which redirection of light requires mirrors of accurate and supported curvature, such as parabolic dish and parabolic trough systems.

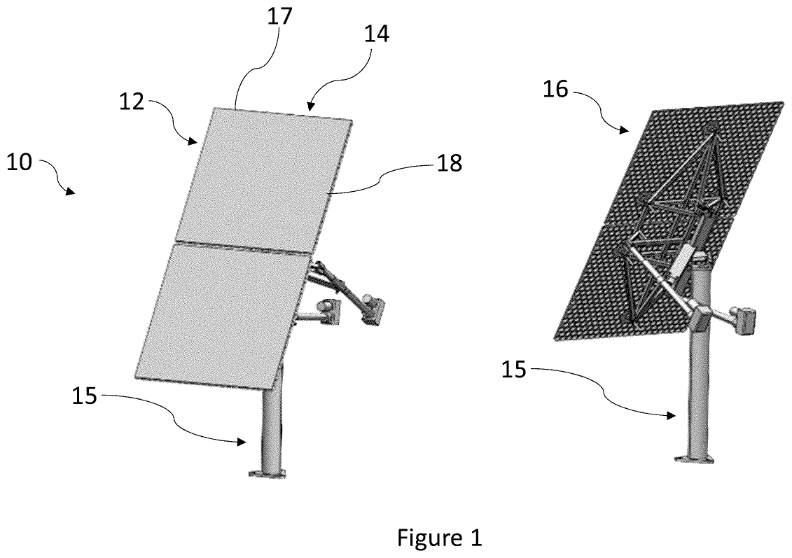

Referring now to FIG. 1, disclosed is a reflector panel assembly 12 employed as part of a solar concentrator system 10.

The reflector panel assembly 12 comprises a reflector in the form of a mirror 14 or a series of mirrors and a support base 16 configured to support the mirror 14 in use. In this illustrated embodiment the support base is supported by a stand 15 to position the mirror for use and allow movement of the mirror as required. The stand comprises an upright post and a base support structure coupled to the upright post.

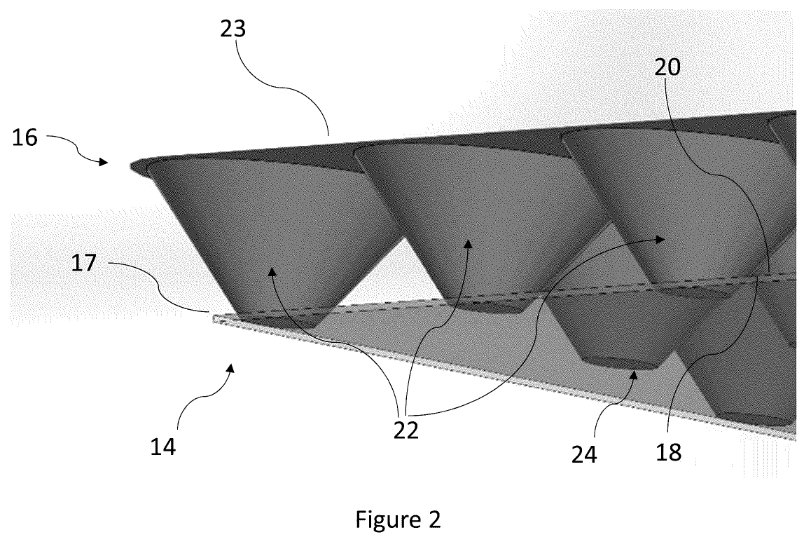

The mirror or reflector 14 comprises a sheet element 17 configured to receive and reflect electromagnetic radiation incident on the sheet element. The sheet element 17 comprises a front surface 18 on which the electromagnetic radiation is incident, and a rear surface 20 (best illustrated in FIG. 2).

In some forms the mirror comprises a sheet element. In some forms the sheet element is laminate. In some forms the sheet element comprises a glass layer and a reflective layer. In some forms the glass layer forms the front surface on which electromagnetic radiation is incident. In some forms the reflective layer comprises a thin layer of a metal such as silver or aluminium located at the rear of the glass layer. In some forms the sheet element further includes one or more protective layers located at the rear of the glass layer, such as a copper layer and one or more paint layers. In some forms the sheet element comprises a glass-on-metal-laminate. In some forms the sheet element comprises a mirror layer and a metal sheet layer. In some forms the sheet element comprises a polished metal layer, such that the front polished surface is the reflective layer. In some forms, the sheet element includes one or more protective layers coated or otherwise located on the reflective layer to protect the reflective layer from undesirable effects such as corrosion for example. In some forms the protective layer is deposited on the sheet element through chemical vapour deposition. The material, dimensions and type of mirror 14 may be varied. For example, for concentration of sunlight, a low-iron content back-surface silvered glass mirror may be employed. In alternative embodiments any beneficial mirror or reflector surface may be employed. For example, mirror 14 may be a glass-on-metal laminate, comprising a thin layer of glass bonded to a thin layer of metal. Another example is a front surface polished aluminium mirror.

The support base 16 of the mirror 14 is configured to support the mirror 14. A contact surface of the support base 16 located at the rear surface 20 is designed to contact the rear surface 20 in such a way to be sufficient to support the mirror and maintain a predetermined shape of the reflector.

The mirror 14 functions to reflect the electromagnetic radiation falling on the sheet element 17. The reflector panel assembly 12 may be sized depending on the requirements of the concentrated solar power system. Sunlight incident on the sheet element 17 is reflected and focused to a desired point/region. The electromagnetic radiation so gathered may be used to generate heat that may be employed for other purposes. For example, water may be heated to turn it into steam, or molten salt may be heated to charge a thermal storage system. The electromagnetic radiation gathered may also be used in other processes, such as electricity generation by photovoltaic cells, or thermochemical processes.

In the preferred embodiment, the sheet element 17 further comprises the following elements which are listed in order from the front surface to the rear surface: a glass sheet, a reflective silver or aluminium layer, a protective copper layer, and one or more protective paint layers. The glass is typically about 3 or 4 mm thick and protects the reflective layer beneath. Thickness is a critical parameter considered in the selection of the glass. For example, simulation results (not shown here) reveal that the stress in the glass may be low enough to allow 3 mm glass to be used. Due to the regular, close spacing of the glass support points, damage due to hail is not considered a particular risk of this design.

The reflective layer may be applied to the back of the glass in a wet chemical deposition process, or other deposition process such as electroplating or vacuum deposition. The reflective layer performs the function of reflecting electromagnetic radiation. The copper and paint layers cover the rear surface of the reflective layer (i.e. one which is not exposed to the incident radiation) thus protecting it from the back side.

In performing the function of reflecting the radiation, the mirror 14 or reflector panel assembly 12 may have a predetermined shape. Typically, a spherical curvature, although alternative shapes are utilised in the field, the shape enables the mirror 14 to focus the reflected electromagnetic radiation at a specific or desired point or region for use. In order for the concentrated solar power system 10 to function effectively, the focal point/region for the reflected radiation is usually predetermined and fixed. For example, the desired point/region can be a receiver located on a tower at a certain height above the ground. The reflector panel 12 is then configured such that it is able to reflect as much of the radiation as possible towards this receiver located on a tower. The shape of the mirror 14 may be tailored depending on factors such as its position relative to the receiver, its position relative to other mirrors in the heliostat, or other factors including economic factors or the geometry of the solar tracker. Often mirrors are shaped with the aim of achieving a spherical curvature with radius equal to double the desired focal length, but sometimes other mirror shapes may be desirable, for example, paraboloidal or asymmetric shapes. Thus, the shape of the mirror 14 has a direct effect on the functioning of the reflector panel 12 and thereby the performance of the concentrated solar power system 10. Any deviations from the predetermined shape will lead to a situation wherein the maximum possible amount of radiation is not directed towards the receiver thus affecting the output of the concentrated solar power system 10. For example, a lesser amount of sunlight reaching the receiver can result in a reduced amount of energy in the form of heat or electricity collected by the receiver. As the shape of the mirror 14 has a direct effect on the performance of the panel, any deviation in the shape from the intended shape can significantly affect the performance of the panel. For example, a spherically curved shape with radius of curvature larger than intended will have a focal point beyond or behind the receiver, and thus in the region of the receiver the light will be more dispersed and some of it may miss the receiver and not be collected.

In use, the shape of the mirror 14 can deviate from the target shape owing to a variety of reasons. For example, during fabrication, there may be a spring back effect from moulding due to the nature of materials used in the panel assembly 12. Accordingly, a finished reflector panel assembly 12 can have a slightly larger curvature than desired due to this spring back effect. In operation, external forces due to wind impinging on the panel 12 may cause a distortion of the panel affecting its shape. Gravitational forces acting on the panels may cause a sagging of the panel, impacting the shape of the mirror 14. As the panels change orientation depending on the sun position, the gravitational sag effect is different at different times of the day.

It is desirable for the reflector panel 12 to have high stiffness. The stiffness of the reflector panel 12 is, among other things, dependent upon the distribution of material in the structure. For improved stiffness it is desirable to have a high second moment of area about the neutral axis of bending. Two parameters in the design of the protrusions that influence second moment of area are the area ratio of the support face and the protrusion aspect ratio. The area ratio is defined as the rectangular area of the support structure divided by the area of the face of the protrusions in contact with the mirror. A larger value indicates more material from the metal support base is distributed to the glass reflective sheet which, all else being equal, increases the stiffness of the panel. The protrusion aspect ratio, which is the ratio of the protrusion height to its base diameter, gives a non-dimensional indication of how slender the protrusion is. A larger value indicates a slender protrusion shape, and therefore more efficient use of material to separate the extremities of the reflector panel, hence increased second moment of area and improved stiffness

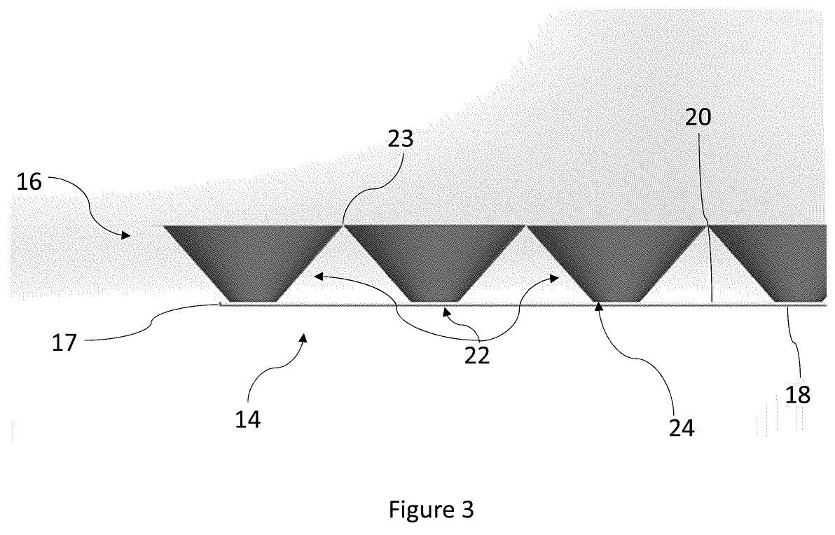

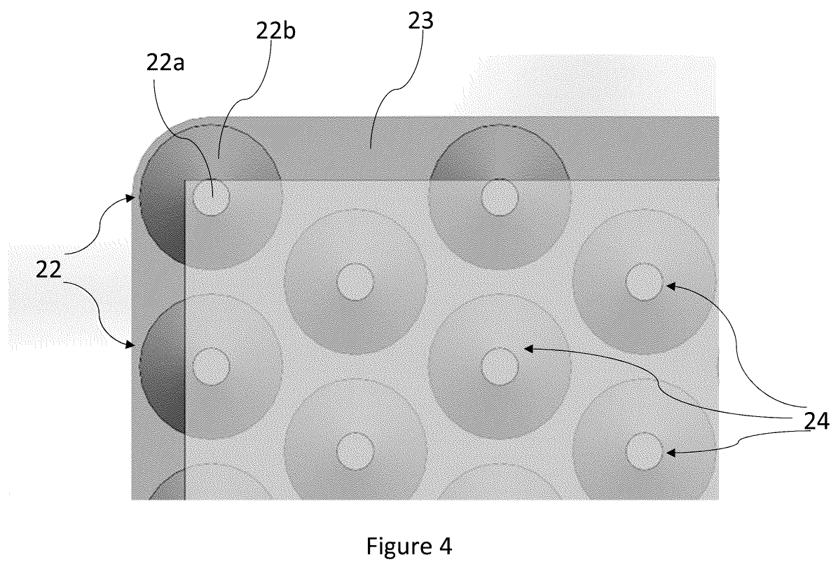

Referring now to FIGS. 2-4, the support base 16 in the illustrated form comprises a panel made up of a series of protrusions 22 which extend from a rear base surface 23 to a contact base surface 24. The contact base surface 24 is configured to contact and support the mirror 14 in use.

In the illustrated embodiment, each protrusion 22 of the support base 16 is in the form of a frusto-conical section protruding out from the rear base surface 23. The contact base surface 24 is formed at the cut-off peak of the frusto-conical sections of the protrusions 22 and comprises multiple spaced apart circular contact surface sections. It will be clear to a person skilled in the art that alternative shapes of protrusion fall within the scope of the disclosure. For example, the cross section of protrusions may be round/square/rectangular or any other appropriate shape.

As shown in FIGS. 2 through 4, each protrusion 22 comprises a contact portion 22a which defines and forms the contact base surface 24 and a curved outer conical surface 22b which extends from the rear base surface 23 to the contact base surface 24. The protrusion outer surface 22b supports the contact base surface 24 away from the rear base surface 23. The length of this outer surface 22b can be varied to adjust the spacing between the rear base surface 23 and the sheet element 17, which in structural engineering terms, increases the second moment of area. In other words, increasing this spacing allows the cross-sectional area related to the sheet element 17 and the rear base surface 23 to be located further from the neutral bending axis, which helps minimise deflections related to bending moments that result from loads such as wind and gravity. Minimising deflection from the desired shape improves optical performance of the mirror panel.

The rear surface 20 of the mirror 14 is in contact with the contact base surface 24 of the base 16. This contact acts to support the mirror 14.

The contact base surface 24 is made up of a plurality of contact portions 22a of the plurality of protrusions 22. Each of the contact portions 22a contact the rear surface 20 of the mirror 14. In the illustrated form each contact portion 22a is circular as forming the cut-off portion of the frusto-conical protrusion. In alternative not-illustrated embodiments the contact portions 22a may comprise alternative shapes.

By providing such a configuration, the base 16 supports the mirror 14 at a plurality of contact portions spaced apart over a wide ranging area. The base provides a plurality of support contacts between the mirror 14 and the base 16, each contact portion providing support across the surface and the contact portions working together to support the sheet member. As a result, the mirror 14 is supported at numerous points spaced across its surface at intervals, to maintain an accurate or consistent shape as desired. The contact portion 22a also facilitates bonding between the support base 16 and mirror 14. For example, an adhesive may be applied on the contact base surface 24 prior to contacting it with the rear surface 20 of the sheet element 17.

Alternative embodiments are available in which the shape and dimensions of the protrusions fashion the configuration and layout of the contact surface. Variations to the contact surface configuration and layout between the base 16 and the mirror 14 result in variations to the support of the sheet element. The spacing of the protrusions on the contact surface results in variety of pattern, configuration and layout of the contact surface. In some forms the protrusions may be regularly spaced.

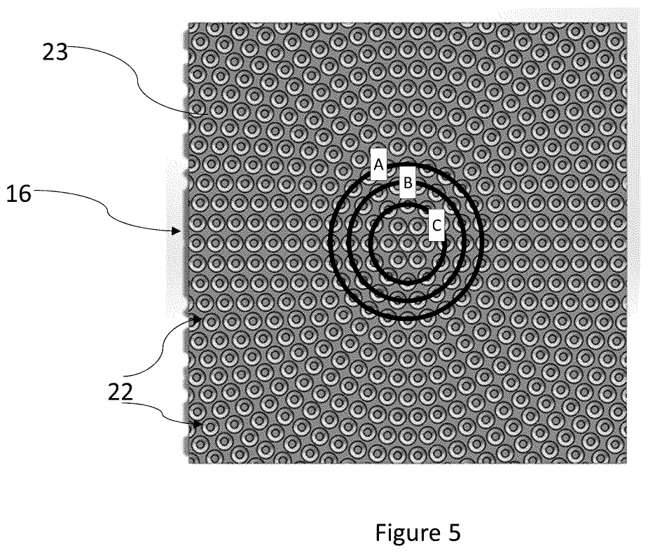

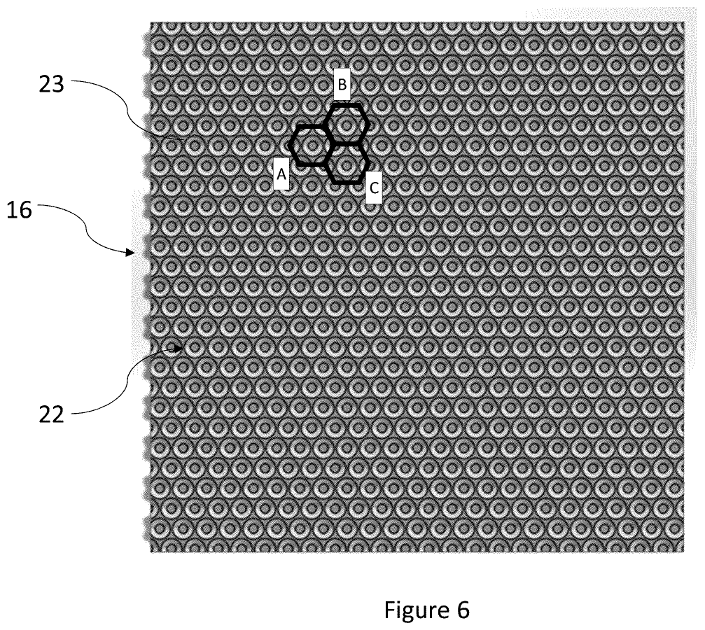

Referring to FIGS. 5 and 6, the pattern of the protrusions may be varied to obtain different configurations of the base 16. In one embodiment (shown in FIG. 5), the protrusions 22 may be arranged in a repeating circular pattern (indicated by overlayed concentric circles A, B, C, which do not form part of the protrusions). As can be seen, concentric circles of protrusions 22 can be formed on the base 16 radiating outwardly from a central section. This provides a regular pattern of supportive protrusions 22.

In another embodiment, best shown in FIG. 6, the protrusions 22 can be arranged in a repeating honeycomb or hexagonal pattern (indicated by overlayed hexagons A, B, C, which do not form part of the protrusions). The protrusions are arranged in offset rows across the surface of the base.

Alternative embodiments are also envisioned. By varying the pattern, the number of protrusions that can be placed in a given area can be varied and the support provided to different sections of the mirror can be varied. This would again result in a variation of the contact surface between the base 16 and the mirror 14.

The base 16 functions to prevent/minimize such deviations to the shape of the mirror 14. The contact base surface 24 made up of multiple spaced apart contact portions 22a of the base 16 allow for significant support to be provided across the full range of the rear surface 20 of the mirror 14. Because of the enhanced anchoring effect achieved by spacing the protrusions 22 in this manner, forces acting locally on a section of the mirror 14 will be limited in their ability to deflect that section of the mirror from its original position. Thus, the resulting reflector assembly 12 may be resistant to deviations in shape induced by forces acting on the mirror.

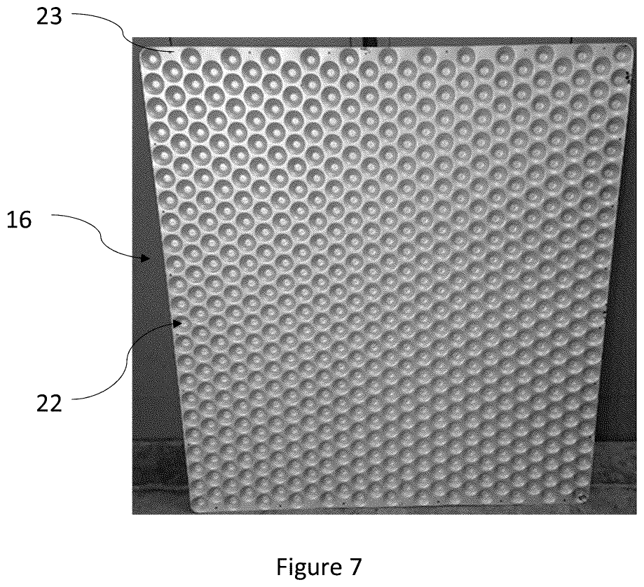

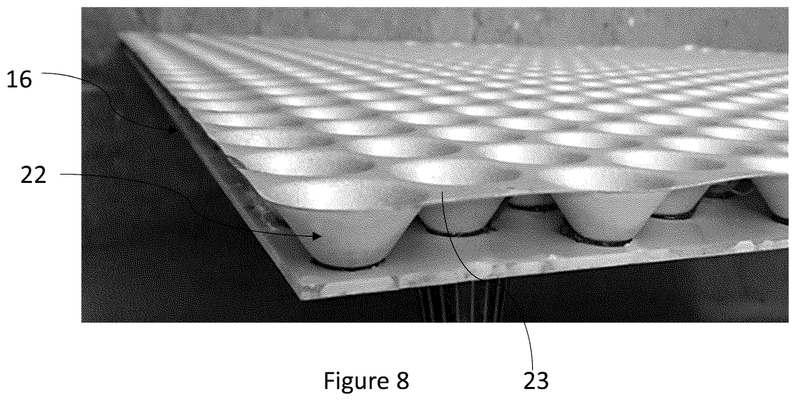

Referring to FIGS. 7 and 8, further views of the base 16 are shown comprising a rear base surface 23 and a contact base surface 24 defined by the contact portions 22a of a plurality of protrusions 22. The base is formed from a sheet metal material. In the illustrated embodiments, the base 16 comprises a plurality of identical or similar protrusions 22 spaced apart across its surface. The positioning and shape of the protrusions may be pre-planned, or designed, on the sheet. The base is formed from a suitable sheet and the protrusions are formed on the sheet through a sheet metal forming operation, such as stamping, turret punching or incremental sheet forming (ISF). The use of a sheet metal stamping operation enables the base 16 to be fabricated in a process that is well suited for large scale manufacturing. The protrusions can be formed in a single step process such as stamping, through multiple step processes such as using a turret punch, or formed through an incremental process (i.e. deformation occurring in small steps) such as ISF (with forms of ISF involving either a single head or multiple heads), thereby ensuring precise accuracy of the protrusions is maintained. The use of sheet metal forming processes in production of the base allows for production in an efficient and inexpensive mass manufacturing production that reduces overall costs and provides consistency in production.

### Materials for Base 16

In some forms, the base is formed from a suitable sheet material.

Key criteria for the selection of a sheet material suitable for the base 16 are formability, suitability for external exposure on solar sites, compatibility with adhesive and cost. In some forms, the strength requirements for the support structure are low since the stresses that occur in use, as determined through finite element analysis, are relatively low (˜50 MPa) compared to the tensile strength of the material. Weight may also be a consideration in deciding the material, but it is not a key criteria.

In the illustrated embodiment, the sheet material is an Al—Zn alloy coated structural steel (Bluescope Zincalume G300). In another embodiment, the sheet material is a Zn coated commercial forming steel (Bluescope Galvabond G2). In other embodiments, stainless steel, and other structural, drawing and forming grade steels can be used.

### Coatings for Corrosion Resistance

In some embodiments, to provide suitable corrosion resistance, coatings may be applied to the material of the base 16. In some forms, the coating may be of zinc or aluminium-zinc alloys.

### Manufacturing Techniques

In some forms, the protrusions are formed through stamping, turret punching, rolling, incremental sheet forming (ISF), or alternative forming methods.

In some forms the base is formed in any manner in which protrusions can be formed in sheet material. In some forms the method of forming is appropriate for mass-production.

The manufacturing method may advantageously have the following characteristics:
High rate of bulk material production
Flexibility to produce different dimensions of finished product
Suitability for on-site production, achieved by simplicity of tooling and machines used

In this regard, stamping can be a potential manufacturing method, but requires a significant commitment of capital to establish. Other less capital-intensive manufacturing methods exists, albeit often at lower production rates. In some forms, these manufacturing methods may be any one of the following:
Incremental sheet forming (ISF) with a single head or multiple heads on a CNC router machine
A cluster-type tool fitted with multiple forming bits
Pin roller forming of material
Embossing or turret punching

While not disclosed explicitly, it will be appreciated that different equipment can be utilised for the above processes. For example, for stamping mechanical/hydraulic presses of different tonnages can be utilised. Press lines can be directly fed from steel coils, or loaded with pre-cut blanks. Multiple stamping stages/operations can be used, for blanking, piercing, forming (including stepped forming stages) and trimming. The number of operations increases tooling and production costs, so efforts are made to minimise the operations. Loading and unloading can be fully automated.

In alternative not-illustrated embodiments, the protrusions 22 may vary across the base in shape and size or may be positioned at regular or irregular intervals across the surface of the base to provide the necessary support.

### Simulations of Manufacturing Processes

In some forms, simulations can be performed to determine the suitability of other manufacturing processes for fabrication. Such simulations can be performed using software specifically designed for the stamping (examples include Autoform, EasyBlank, Altair Inspire Form etc). These simulations can provide useful information on whether a manufacturing process is suitable to create a specific design of the base 16. For example, it can be estimated if stamping can be used to create a protrusion 22 with a certain depth and a certain base diameter.

Similarly, the simulations can also assist in deciding which is the optimum geometry to be utilized from the perspective of forming and which is the best starting geometry for a given forming process. For example, it is possible to test different shapes of protrusions to assess which gives the best formability and reduces press tonnages and which is the most ideal starting geometry etc.

Adhesives and their Selection

In some forms, to produce a curved reflector 12, adhesive is applied to the contact base surface 24, and the mirror 14 and base 16 are deformed elastically onto a curved mould and held together until the adhesive cures and is sufficiently strong to resist the springback forces and hold the reflector in shape. During this curing period the mirror and base may be held together by weights, a press, a vacuum bag system or by other means.

Given that the other components of the panel have long life, it may be advantageous to choose an adhesive that has a comparable life when exposed to the elements. For example, plants typically have a design life of 25 years. Accordingly, it may be advantageous to have a panel 12 that is able to survive in service for the duration of the plant life cycle.

The adhesive may advantageously be suitable for rapid assembly during high volume manufacturing. The assembly process requires a balance of open time, working time and curing time. The adhesive needs to be applied over a significant surface before the support structure is manoeuvred into place and lowered onto the mirror. Therefore, the working time may advantageously be in the order of several minutes. After the support is placed on the mirror, pressure is applied for the assembly to take the shape of the mould. During this process it would be advantageous for the adhesive to be able to freely move and mould to the shape. The moulding time may only require a few seconds. Finally, rapid curing may be advantageous so that mirrors can be produced at an acceptable rate. Longer cure rates will result in more moulds being required to keep up the production rate and this may increase costs and possibly affect the accuracy of the moulds. A solution to the problem of long curing times may be that due to the low bond stresses a full cure may not be required. Testing of the adhesives can be done to determine how long the adhesive needs to cure before the reflector 12 can be safely handled. As an example, the open time may advantageously be around 5 minutes or more, the working time can be at least a few seconds and the curing time to handle can be approximately 15 minutes.

Given that the panel is located outdoors, the adhesive will also need to withstand a range of operating temperatures. In some forms, it may be advantageous to have an adhesive that is able to withstand operating temperatures at least in the range of −10° C. to 90° C. In deciding the range of temperatures, diurnal temperature changes that occur may be considered, along with temperatures that may be experienced due to light being reflected from one mirror onto an adjacent nearby mirror. It will be apparent to a person skilled in the art that there are no upper and lower limits on the range of temperatures as long as the other functional requirements such as maintaining bond integrity, ease of assembly etc are met. For example, the lower limit of operating temperatures may be −20° C. or −30° C. or lower. Similarly, the upper limit of operating temperatures may be 110° C. or 120° C. or more.

The bond formed by the adhesive should be able to withstand stresses generated in use. Without being bound by theory, simulations that take into consideration various factors may be performed to estimate such stresses. For example, these factors may include the external loads experienced by the mirror panel in operation (wind, snow, seismic, etc.), springback effects from the manufacturing process, the weight of the components (gravitational load) and thermal expansion/contraction loads caused by temperature changes due to sunlight and variation in ambient conditions are some of the factors that may be used in the simulations. The bond formed by the adhesive may also advantageously withstand creep or other instability mechanisms that occur when a material is placed under stress for prolonged periods of time.

The adhesive may advantageously be able to withstand weathering by exposure to thermal cycles, humidity cycles, prolonged exposure to moisture, and exposure to UV light. Since the contact points are for the most part shadowed by the mirror surface and the support structure, mid-class resistance to UV light may offer sufficient protection.

An adhesive that may satisfy some or all of the requirements listed above is a two-part acrylic adhesive. These two-part adhesives provide excellent bond strength and durability. They are easy to use in many applications and manufacturing processes because of their fast cure speed and high tolerance for oily or unprepared bonding surfaces.

In other embodiments, other types of adhesives which satisfy the functional requirements above may also be chosen. For example, the adhesive could be chosen from amongst epoxies, silicones and/or pressure-sensitive adhesives.

### EXAMPLES

The following examples illustrate the fabrication and testing of a solar panel reflector assembly according to the invention.

### Example 1—Prototyping of Small-Scale Mirror Panel

This example illustrates development and prototyping of two small-scale mirror panels (Mirror A and Mirror B). The physical characteristics of these panels are shown in Table 1 below.

TABLE 1
Physical characteristics of two small-
scale reflector panel assemblies

| | |
|---|---|
| Glass length (mm) | 1130 |
| Glass width (mm) | 1070 |
| Glass thickness (mm) | 3 |
| Protrusion top diameter (mm) | 20 |
| Protrusion base diameter (mm) | 45.2 |
| Draft angle (degrees) | 50 |
| Protrusion spacing (mm) | 50 |
| Area ratio | 0.34 |
| Aspect ratio | 0.33 |

Mirrors were manufactured from solar mirror glass obtained from suppliers available on the market. The mirror glass was supplied in the required dimensions and with edges that are ground to a rounded shape and have coatings applied to the edge of the glass. Silvered mirror coatings are applied to glass through a process involving cleaning, sensitization, immersion in a silvering bath, rinsing, protective coating application, and drying. The silvering bath typically contains silver nitrate and a reducing agent to deposit a reflective silver layer, and a protective paint coating is added to preserve the mirror's integrity

The base 16 was manufactured by incremental sheet forming on a CNC router using an medium density fibreboard (MDF) mould as a base plate. The material chosen was 0.4 mm thick G300 Zincalume steel sheet.

An acrylic adhesive was employed. It has a moderate working time which is more suitable to the hand assembly process used during prototyping.

The mirror panels were assembled on a suitable convex mould, with the glass laid face down on the convex mould. A pea sized amount of adhesive was applied to each of the protrusions. The support was then placed on the glass and covered with the plastic sheet for vacuum forming. The vacuum was then drawn and controlled to approximately −15 kPa. The process was completed within a few minutes to avoid the adhesive setting before the required vacuum was achieved.

The field test panels were painted in white washable paint and placed on a stand where they are supported by one edge of the panel. An image of dots was projected at the painted surface and photographed from multiple angles for photogrammetry analysis.

The results showed that the mirrors have some springback from the shape of the mould, but have a very low slope error, indicating a high optical quality mirror panel (Table 2).

TABLE 2
Slope error and radius of curvature (ROC) results.

| | Slope error | ROC |
|---|---|---|
| Mirror | (mrad) | (m) |
| A | 0.62 | 36.3 |
| B | 0.49 | 43.2 |

### Example 2—Prototyping of a Large Scale Mirror Panel

This example illustrates the development of a prototype large-scale mirror panel which is more representative of the scale common in heliostats.

The backing support structure is made using the single point incremental forming (SPIF) process, and therefore the dimensions of the panel are roughly determined by the maximum dimensions that can be formed on the CNC router at the Australian National University, or approximately 2.8 m×1.4 m. The material selected for the base 16 was an inexpensive and readily available galvanised forming steel, grade G2 with a thickness of 0.6 mm.

An acrylic adhesive was selected as the adhesive to assemble the prototype.

A hexagon shape protrusion pattern was laid out on a sheet that fits into the maximum dimension of the router table. The glass is slightly smaller than the support because the protrusions taper inward and the resulting glass dimensions were 2840 mm×1400 mm.

Glass was obtained from suppliers available on the market. The thickness was selected by comparing costs and confirming its suitability with finite element analysis.

The dimensions of the prototype large scale reflector panel are shown below in Table 4.

TABLE 4
Physical characteristics large reflector panel assembly

| | |
|---|---|
| Glass length (mm) | 2840 |
| Glass width (mm) | 1400 |
| Glass thickness (mm) | 3 |
| Protrusion top diameter (mm) | 34.3 |
| Protrusion base diameter (mm) | 134.1 |
| Draft angle (degrees) | 52.5 |
| Protrusion spacing (mm) | 156 |
| Radius of curvature (m) | 120 |
| Area ratio | 0.37 |
| Aspect ratio | 0.48 |

The SPIF process was used to form the shape of the protrusions, again using an MDF backing structure.

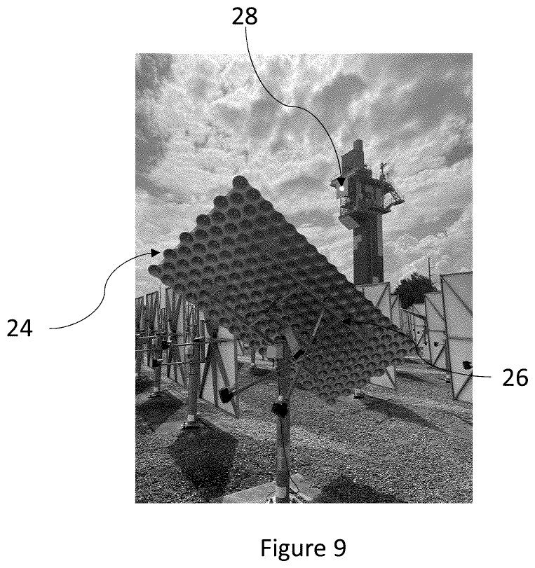

The glass was laid face down on a convex mould manufactured from MDF, followed by the support structure. The backing structure was held down to the mould by applying a combined tension and pull down force to the edges. To simplify handling, in this case adhesive was applied by injecting through holes drilled in the centre of each protrusion, until the adhesive started to flow out of the gap indicating that the gap was filled with adhesive. The completed mirror panel 24 (shown in FIG. 9) was mounted on an H-shaped frame 26 and installed within a heliostat field. Refer to FIGS. 9, which shows the heliostat (completed mirror panel 24, mounted on an H-shaped frame 26) in the field, and the reflected image 28 from this heliostat on the flux target.

Variations and modifications may be made to the parts previously described without departing from the spirit or ambit of the disclosure.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1.-13. (canceled)

14. A method of manufacturing a base to support a reflector for use in a concentrated solar power system, the base composed of sheet material and comprising a plurality of protrusions spaced apart in a predetermined arrangement of protrusions across a surface of the base, the plurality of protrusions extending from a rear surface to contact portions at peaks of the protrusions, the contact portions configured to form a contact surface which supports the reflector in use, the method comprising:
providing a backing structure having cavities configured to receive material subjected to deformation;
providing a base sheet comprising the sheet material to be deformed;
preparing the surface of the base sheet to be in contact with a forming tool;
contacting a predetermined location on the surface of the base sheet with the forming tool;
applying a series of incremental loads to the predetermined locations on the base sheet such that the sheet material of the base sheet is deformed into the cavities of the backing structure to form the predetermined arrangement of protrusions on the base.

15. A method according to claim 14, wherein the forming tool comprises either a single head or multiple heads.

16. A method according to claim 14, wherein the base sheet is zinc coated steel or an Al—Zn alloy coated structural steel.

17. A method according to claim 14, wherein the series of incremental loads are applied in discrete steps.

18. A method according to claim 14, wherein the series of incremental loads are applied in a gradual, continuous manner.

19. A reflector panel assembly for use in a concentrated solar power system, the assembly comprising:
a reflector comprising a sheet element configured to receive and reflect electromagnetic radiation, the sheet element having a front surface on which electromagnetic radiation is incident and a rear surface;
a base configured to support the reflector such that a contact surface between the rear surface and the base is configured to maintain a predetermined shape of the reflector.

20. The assembly according to claim 1, wherein the base comprises a plurality of protrusions extending from a rear base surface to form the contact surface, the contact surface being spaced apart from the rear base surface.

21. The assembly according to claim 1, wherein the contact surface of the base comprises a plurality of spaced apart contact surface portions formed at a peak of each of at least a portion of the protrusions.

22. The assembly according to claim 2, wherein the protrusions are frusto-conical extending from a base at the rear base surface to the contact surface.

23. The assembly according to claim 2, wherein the plurality of protrusions are evenly spaced apart on the base.

24. The assembly of claim 2, wherein the protrusions are located in a regular pattern on the base.

25. The assembly of claim 1, wherein the base is composed of sheet metal.

26. The assembly of claim 7, wherein the protrusions are manufactured through sheet metal forming.

27. The assembly of claim 8, wherein the protrusions are manufactured through sheet metal stamping, turret punching or incremental sheet forming.

28. A base configured to support a reflector for use in a concentrated solar power system, the base composed of sheet material and comprising a plurality of protrusions spaced apart across a surface of the base, the plurality of protrusions extending from a rear surface to contact portions at peaks of the protrusions, the contact portions configured to form a contact surface which supports the reflector in use.

29. A base as defined in claim 10, wherein the base is composed of sheet metal and the protrusions are formed by sheet metal forming.

30. A base as defined in claim 11, wherein the sheet metal forming comprises stamping, turret punching or incremental sheet forming.

31. A method of manufacturing a base to support a reflector for use in a concentrated solar power system, the method comprising providing a sheet material, and forming a plurality of protrusions in the sheet material, the plurality of protrusions being spaced apart across a surface of the base and extending to contact portions at a peak of each protrusion, the contact portions configured to together form a contact surface which supports the reflector.
